(19) United States
(12) Patent Application Publication
(10) Pub. No.: US 2024/0298668 A1
(43) Pub. Date: Sep. 12, 2024

(54) PLANT-BASED VEGAN BEATEN EGG COMPOSITION

(71) Applicant: Float Foods PTE Ltd, Singapore (SG)

(72) Inventors: Vinita M. Choolani, Singapore (SG); Mathilde Laura Bancillon, Singapore (SG); Keshav Raj, Singapore (SG)

(73) Assignee: Float Foods PTE Ltd, Singapore (SG)

(21) Appl. No.: 18/573,230

(22) PCT Filed: Aug. 30, 2021
(86) PCT No.: PCT/SG2021/050521

§ 371 Date: Dec. 21, 2023

(30) Foreign Application Priority Data
Jun. 25, 2021 (SG) 10202107001S

(51) Int. Cl. A23J 3/16; A23L 15/00

(52) U.S. Cl. CPC A23J 3/16; A23L 15/35

(57) ABSTRACT

The present invention is directed to plant-based vegan egg compositions and methods of producing such compositions. The plant-based vegan egg compositions of the invention comprise tofu, flour, water, kala namak, a plant-based cream, tapioca starch, corn starch, natural yellow food colouring, white pepper powder, garlic powder, onion powder and a gum. In specific embodiments of the invention, the vegan simulated beaten egg compositions are used for producing an omelette, an egg patty, or shreds.

### FIELD OF THE INVENTION

The present invention is directed to plant-based vegan simulated beaten egg composition and methods of producing such compositions. More particularly, the invention provides, for example, vegan simulated beaten egg compositions for producing a simulated egg omelette, a simulated egg patty, or simulated egg shreds.

### BACKGROUND OF THE INVENTION

It is well known that some characteristics of egg and egg products are often cause for concern, and otherwise impede the ability for some people to consume food products having egg products therein. For example, many individuals may be unable to, or would prefer not to consume egg products due to egg allergies, health concerns associated with cholesterol, culinary preferences (such as, a Vegetarian or vegan diet), use of antibiotics and hormones during poultry production, and diseases associated with poultry (such as, for example, bird flu). Additionally, the high cost and/or cost fluctuations in the price of eggs and the contamination of salmonella carried by eggs have also been a concern of food manufacturers.

In addition, the world's ability to provide a growing population with adequate and nutritious food is becoming fragile due to environmental degradation and climate change. In the newer food product group, the nutraceutical and functional food market is one of the fastest-growing food segments.

Covid19 has exacerbated food-safety concerns in Singapore and around the world. Singapore has an urgent need to build its food resilience and security, as a country that imports 74% of its entire supply of eggs. The government has put in place the 30 by 30 initiative, with the aim of putting in place initiatives for the country to produce 30% of its nutritional needs locally by 2030.

In light of these concerns, there is a need for simulated egg compositions that can be produced locally, and that will mimic, visually and sensorily, animal-derived eggs, particularly avian eggs, more specifically chicken eggs or their components.

### SUMMARY OF THE INVENTION

The present invention is directed to plant-based vegan egg compositions, methods of producing such compositions, and food products from said compositions. More particularly, the invention provides, for example, vegan simulated beaten egg compositions for producing an omelette, an egg patty, or shreds. The invention provides vegan simulated egg compositions having the sensory properties and/or function of beaten chicken yolks and whites.

In a first aspect, the invention provides a plant-based vegan simulated beaten egg composition comprising the components;

tofu, flour, water, kala namak, a plant-based cream, tapioca starch, corn starch, natural yellow food colouring, white pepper powder, garlic powder, onion powder, and a gum.

In some embodiments of the plant-based vegan simulated beaten egg composition; the tofu is silken tofu; and/or
the flour is selected from rice, wheat, chickpea, buckwheat, corn, potato and spelt, preferably rice flour; and/or
the plant-based cream is selected from coconut, rice, oat, cashew and almond cream, preferably coconut cream; and/or
the gum is selected from a group of elastic gel-forming gums, preferably high acyl gellan gum; and/or the natural yellow food colouring is selected from the group comprising:
lutein (IUPAC ID: 4-[18-(4-hydroxy-2,6,6-trimethylcyclohex-2-en-1-yl)-3,7,12,16-tetramethyloctadeca-1,3,5,7,9,11,13,15,17-nonaenyl]-3,5,5-trimethylcyclohex-3-en-1-ol); and
beta carotene (IUPAC ID: 1,3,3-trimethyl-2-[(1E,3E,5E,7E,9E,11E,13E,15E,17E)-3,7,12,16-tetramethyl-18-(2,6,6-trimethylcyclohexen-1-yl)octadeca-1,3,5,7,9,11,13,15,17-nonaenyl]cyclohexene).

Preferably the natural yellow food colouring is lutein.

In some embodiments, the plant-based vegan simulated beaten egg composition further comprises;
(i) plant protein; or
(ii) plant protein, baking powder, and methylcellulose.

Plant protein may be included to increase the nutritional value of the products of the invention. Further adding baking powder and methylcellulose allows baking of the plant-based vegan simulated beaten egg composition into omelettes and patties.

In some embodiments, the baking powder is a single-acting baking powder.

In some embodiments, when the plant-based vegan simulated beaten egg composition further comprises plant protein, the composition comprises;
tofu in an amount of about 60-65 wt %, plant protein in an amount of about 5-10 wt %, flour in an amount of about 1-5 wt %, kala namak in an amount of about 0.5-2 wt %, plant-based cream in an amount of about 1-5 wt %, tapioca starch in an amount of about 0.5-2 wt %, corn starch in an amount of about 0.5-2 wt %, gum in an amount of about 0.5-2 wt %, garlic powder in an amount of about 0.1-2 wt %, onion powder in an amount of about 0.1-2 wt %, white pepper powder in an amount of about 0.1-2 wt %, natural yellow colouring in an amount of about 0.01-1 wt % and water in an amount of about 20-25 wt %, by weight of said beaten egg composition.

Such a composition may be used to produce a vegan simulated fried egg omelette, which may be further cut into vegan egg shreds.

In some embodiments, the plant protein is fava bean protein, preferably fava bean concentrate.

In some embodiments, when the plant-based vegan simulated beaten egg composition further comprises plant protein, baking powder, and methylcellulose, the composition comprises; tofu in an amount of about 60-70 wt %, plant protein in an amount of about 1-5 wt %, flour in an amount of about 5-10 wt %, kala namak in an amount of about 0.1-2 wt %, plant-based cream in an amount of about 5-10 wt %, tapioca starch in an amount of about 0.1-2 wt %, corn starch in an amount of about 0.1-2 wt %, gum in an amount of about 0.1-2 wt %, baking powder in an amount of about 0.1-2 wt %, natural yellow colouring in an amount of about 0.01-1 wt %, white pepper powder in an amount of about 0.1-2 wt %, onion powder in an amount of about 0.1-2 wt %, garlic powder in an amount of about 0.1-2 wt %, methylcellulose in an amount of about 0.1-2 wt % and water in an amount of about 10-15 wt %, by weight of said beaten egg composition.

Such a composition may be used to produce a vegan simulated baked egg omelette or simulated baked egg patty.

In some embodiments, when the plant-based vegan simulated beaten egg composition includes plant protein, baking powder and methylcellulose, the plant protein is pea protein, preferably pea protein isolate.

In some embodiments, the plant-based vegan simulated beaten egg composition comprises:
tofu in an amount of about 60.4 wt %, fava bean protein concentrate in an amount of about 8.2 wt %, flour in an amount of about 1.4 wt %, kala namak in an amount of about 0.56 wt %, coconut cream in an amount of about 2.8 wt %, tapioca starch in an amount of about 0.56 wt %, corn starch in an amount of about 0.56 wt %, gum in an amount of about 0.7 wt % garlic powder in an amount of about 0.42 wt %, onion powder in an amount of about 0.22 wt %, white pepper powder in an amount of about 0.17 wt %, natural yellow colouring in an amount of about 0.08 wt % and water in an amount of about 23.9 wt %, by weight of said beaten egg composition.

In some embodiments, the plant-based vegan simulated beaten egg composition comprises:
tofu in an amount of about 67.3 wt %, pea protein isolate in an amount of about 1.9 wt %, rice flour in an amount of about 6.3 wt %, kala namak in an amount of about 0.6 wt %, coconut cream in an amount of about 6.3 wt %, tapioca starch in an amount of about 0.63 wt %, corn starch in an amount of about 0.63 wt %, gum in an amount of about 0.94 wt %, baking powder in an amount of about 1 wt %, natural yellow colouring (lutein) in an amount of about 0.09 wt %, white pepper powder in an amount of about 0.19 wt %, onion powder in an amount of about 0.13 wt %, garlic powder in an amount of about 0.31 wt %, methylcellulose in an amount of about 1.3 wt % and water in an amount of about 12.5 wt %, by weight of said beaten egg composition.

According to another aspect, the present invention provides a method of producing a vegan simulated beaten egg composition of any aspect of the invention, comprising the steps:
i) in a blender, mix tofu, plant protein, flour, water, black salt, plant-based cream, tapioca starch, corn starch, gum, colouring, garlic powder, onion powder and white pepper powder for 1 minute until smooth and homogeneous; or
ii) in a blender, mix tofu, plant protein, flour, water, black salt, plant-based cream, tapioca starch, corn starch, gum, baking powder, colouring, white pepper powder, onion powder, garlic powder and methylcellulose for 1 minute until smooth and homogeneous,
wherein the composition of (i) may be used for preparation of pan-fried omelette which may be further cut into vegan egg shreds, and
wherein the composition of (ii) may be used for the preparation of a vegan oven-baked omelette or vegan oven-baked egg patty.

According to another aspect, the present invention provides a vegan simulated omelette, vegan simulated egg patty or vegan simulated egg shreds, produced by the method described above.

According to another aspect, the present invention provides a kit or combination comprising a plant-based vegan simulated beaten egg composition of any aspect of the invention. The kit may comprise packaging for storing and/or dispensing said plant-based vegan simulated beaten egg composition, and may further include instructions for use of said composition.

### BRIEF DESCRIPTION OF THE FIGURES

FIG. 1 shows a vegan omelette using the Minimalist Baker composition.

FIG. 2 shows a vegan omelette produced using the Edgy Veg composition.

FIG. 3 shows a vegan omelette produced using the Hidden Veggies composition.

FIGS. 4A-4B show, from left to right, a view of a baked chicken egg, JUST Egg, and vegan egg omelette of the invention. 4A: top view. 4B: side view.

FIG. 5 shows a photograph of Vegan egg Shreds of the invention (in the front), and stir-fried chicken egg strips (in the rear).

FIG. 6 shows a photograph of the Vegan egg Shreds of the invention added to fried rice.

FIG. 7 shows a photograph of a Vegan egg patty of the invention used in a burger.

FIG. 8 shows a photograph of a BurgerKing® Croissan'wich with a chicken egg patty.

### DETAILED DESCRIPTION OF THE INVENTION

Bibliographic references mentioned in the present specification are for convenience listed in the form of a list of references and added at the end of the examples. The whole content of such bibliographic references is herein incorporated by reference.

### Definitions

Certain terms employed in the specification, examples and appended claims are collected here for convenience.

It must be noted that as used herein and in the appended claims, the singular forms “a”, “an”, and “the” include plural reference unless the context clearly dictates otherwise.

As used herein, the term “comprising” or “including” is to be interpreted as specifying the presence of the stated features, integers, steps or components as referred to, but does not preclude the presence or addition of one or more features, integers, steps or components, or groups thereof. However, in context with the present disclosure, the term “comprising” or “including” also includes “consisting of”. The variations of the word “comprising”, such as “comprise” and “comprises”, and “including”, such as “include” and “includes”, have correspondingly varied meanings.

Having now generally described the invention, the same will be more readily understood through reference to the following examples which are provided by way of illustration, and are not intended to be limiting of the present invention.

### Example 1: Vegan Egg Omelette/Beaten Egg

A vegan simulated beaten egg composition of the invention is a composition that simulates a beaten whole natural egg, for example a chicken beaten egg. It therefore must provide similar qualities to a mixture of egg yolk and egg white when used in producing products such as omelettes, patties and shreds.

### 1.1 Components

Tofu is cholesterol free, low in saturated fat, and high in protein. On a moisture-free basis, tofu contains about 50% protein and 27% fat, most of which is polyunsaturated fatty acids. Tofu is also a good source of calcium.

In some cases, the plant-based protein used in a plant-based egg white formulation can range into the various types and hardness of tofu. It can also be found in soy yoghurt. It is found that silken tofu is the optimum ingredient for this formulation as it allows for a smooth texture reminiscent of avian eggs. Hard tofu may also be used, though it falls short on various parameters. For instance, hard tofu tends to leave a certain residue which does not resemble the mouthfeel of avian egg whites when used in this formulation.

Rice flour is a thickening agent for the formulation of the plant-based white. Rice flour gives an omelette a white appearance, prevents liquid separation, and increases the viscosity and elasticity of the plant-based white egg mixture which gives it a similar texture to a chicken egg white. Preferably, white rice flour is used as it contributes to the natural colour of the egg white.

In some cases, rice flour may be substituted in the formulation with flours of other origins, which can include wheat, chickpea, buckwheat, corn, potato and spelt. However, rice flour, being inherently white, allows the vegan simulated egg white to remain white as well, to match the fluorescent white colour of a typical fried avian egg white. Its ability to prevent liquid separation also allows for a viscosity, mouthfeel and stretch that is reminiscent of fried avian egg whites

Coconut cream is a source of medium-chain triglycerides (MCT). It lowers the bad cholesterol and increases the good cholesterol, and acts as a good fat substitute to mimic one found in whole chicken eggs. It is also a rich source of B vitamins, vitamin C, vitamin E as well as a source of essential minerals including magnesium and phosphorus.

In some cases, coconut cream may be substituted in the vegan simulated egg white formulation with other plant-based creams that may include rice, oat, cashew and almond cream. Plant-based milks may also be used in lower amounts in the formulation to ensure that the formulation is not too liquid. Such milks may include soy, oat, almond, cashew, rice, hemp, pea or peanut milk.

Black Salt, also known as kala namak, or Himalayan black salt, was chosen for the composition of the plant-based egg white. Black salt consists primarily of sodium chloride and traces of sodium bisulfite and hydrogen sulfide. The sulfur compounds provide black salt its distinctive taste and smell, with hydrogen sulfide being the most prominent contributor, imitating the sulfurous aroma and smell of a whole chicken egg.

In some cases, other forms of salt may be substituted in the vegan simulated egg white formulation. Such salts may include sea salt, himalayan pink salt, kosher salt or regular table salt. While such substitutions may work to simulate the viscosity, colour and mouthfeel of an avian egg white, black salt is found to be the optimum across all parameters as it provides a sulfuric taste that is reminiscent of avian egg whites.

Tapioca Starch is a food thickener and stabilizer. Tapioca Starch is used to improve the taste and texture of the egg, and to give consistency or stickiness to the texture.

In some cases, other forms of starch may be used in the formulation. For instance, corn starch could be used in higher amounts. Other starches like potato and arrowroot could also be used as a substitution. Such starches and compositions would not provide the vegan simulated egg white with certain elements that the tapioca starch provides. Such elements include the fact that tapioca starch adds to the binding properties of the other ingredients used for the composition. The element of colour is also optimised towards that of an avian egg when tapioca starch is used, as it provides more of a glossy finish.

Corn Starch is a tasteless thickening agent that does not interfere with the taste profile of the overall composition.

Much like the tapioca starch used in the formulation, corn starch may be substituted with other starches including potato and arrowroot to create the plant-based egg white. That being said, cornstarch has a binding property that allows it to complement the other ingredients in ensuring the texture of the vegan simulated egg white is very similar to that of an avian fried egg white.

Egg yellow food colouring may be used to enhance the colour of the beaten egg composition and products made therefrom. The food colouring may be selected from the group comprising lutein (IUPAC ID: 4-[18-(4-hydroxy-2,6,6-trimethylcyclohex-2-en-1-yl)-3,7,12,16-tetramethyloctadeca-1,3,5,7,9,11,13,15,17-nonaenyl]-3,5,5-trimethylcyclohex-3-en-1-ol) and beta carotene (IUPAC ID: 1,3,3-trimethyl-2-[(1E,3E,5E,7E,9E,11E,13E,15E,17E)-3,7,12,16-tetramethyl-18-(2,6,6-trimethylcyclohexen-1-yl)octadeca-1,3,5,7,9,11,13,15,17-nonaenyl]cyclohexene).

Gum. Guar gum, gellan gum, xanthan gum may be used. Preferably the type of gum used in the vegan beaten egg composition is guar gum, gellan gum or xanthan gum. Guar gum hydrates readily in cold water and thickens solutions at low concentration. Gellan gum may be used for the purpose of providing the strength and stretch of the vegan egg patty of the invention to match that of a chicken egg. The native type (high acyl) gellan gum is used because it forms soft elastic transparent gels that can help to not only bind all the ingredients together, but also re-create the springiness and slight elastic characteristic associated with a cooked egg omelette. The optimal amount of gellan gum used in the vegan egg patty formulation ranges from 0.1 wt % to 2 wt %. Xanthan gum is considered to be very similar to (high acyl) gellan gum, in that they are both exopolysaccharides biosynthesized from the bacterial fermentation process and form a soft, elastic gel. However, high acyl gellan gum is preferred because it provides better moisture retention, flavor release and storage stability.

Plant protein is used for protein enrichment. Preferably the type of plant protein used in the vegan beaten egg (shreds) composition is fava (faba) bean protein. More preferably a fava bean concentrate is used which comprises 60% protein on a dry basis. To produce a concentrate, dehulled split fava bean cotyledons of faba beans (Vicia faba) are mechanically milled and processed. The protein undergoes proprietary physical treatment that provides a cleaner flavor profile, which enables high inclusion rate with no flavor impact. An example of a fava bean concentrate is marketed as VITESSENCE™ Pulse CT 3602 Protein-37401G00 by Ingredion Incorporated. Alternatives include chickpea, pea, rice, sunflower, soy, mungbean proteins, but the fava bean protein is preferred because it confers best sensory textural attributes and possesses great solubility which facilitates use in high moisture applications. In some embodiments, the vegan beaten egg composition comprises fava bean concentrate in a range of about 5-10 wt %. On the other hand, NUTRALYS® F85M which is a pea protein isolate from Roquette that comprises 85% protein on a dry basis is the preferred plant protein for the baked beaten egg composition. Alternatives include chickpea, fava bean, rice, sunflower, soy, mungbean proteins, but this functional pea protein is used because it provides desirable gelling property for even cell structure in baked goods. The pea protein isolate may be produced using a patented water-based process [U.S. Pat. No. 7,186,807] after the peas are ground and converted into flour. Protein that coagulates into a paste will be subsequently solubilised, spray-dried, and granulated. In some embodiments, the vegan beaten egg patty composition comprises pea protein isolate in a range of about 1-5 wt %.

Baking powder and methylcellulose are used to produce a baked beaten egg product in an oven. The baking powder causes the bubbles in a wet beaten egg mixture to expand. This is used to increase the volume and lighten the texture of our baked omelette or patty that would otherwise be very dense. Both single acting and double acting baking powder were tested and both were equally effective as leavening agents, as they produce the same amount of gas. However, single-acting baking powder is good enough for this application as it is easier to control for the rate and extent of mixing in a commercial or industrial setting and thus will prevent the occurrence of overmixing. This eliminates the need to use double-acting baking powder. Methylcellulose helps the baked patty gain volume and retain air cells during baking.

White pepper powder, garlic powder and onion powder are added to further recreate or mimic the sensory experience (mainly oral and visual perceptions) derived from normal, seasoned omelette made with chicken eggs.

Water is also added to thin the entire beaten egg mixture so that the mixture will exhibit a shear thinning behavior when force is applied, like a real beaten egg would behave when beaten or stirred for a certain period of time.

The above ingredients provide binding, emulsifying, leavening and thickening properties to the mixture, in addition to taste and flavour similar to eggs.

The beaten egg composition of the invention varies depending on intended use. For example, for the production of vegan egg shreds or omelette the composition is formulated as shown in Table 1.

TABLE 1
Composition of vegan beaten egg (shreds)

| Ingredient | Composition (wt %) |
|---|---|
| tofu | 60-65 |
| Faba bean protein | 5-10 |
| concentrate | |
| rice flour | 1-5 |
| water | 20-25 |
| Kala Namak (Black salt) | 0.5-2 |
| Coconut cream | 1-5 |
| tapioca starch | 0.5-2 |
| corn starch | 0.5-2 |
| gum | 0.5-2 |
| Garlic powder | 0.1-2 |
| Onion powder | 0.1-2 |
| White pepper powder | 0.1-2 |
| Natural yellow colour | 0.01-1 |
| (Lutein) | |

In some embodiments, the vegan beaten egg composition is to be used for production of vegan simulated egg patties. For this use, instead of adding faba bean protein concentrate, the composition preferably further comprises pea protein isolate, baking powder and methylcellulose as shown in Table 2.

TABLE 2
Composition of vegan beaten egg (patty)

| Ingredient | Composition (wt %) |
|---|---|
| tofu | 60-70 |
| Pea protein isolate | 1-5 |
| rice flour | 5-10 |
| water | 10-15 |
| Kala Namak (Black salt) | 0.1-2 |
| Coconut cream | 5-10 |
| tapioca starch | 0.1-2 |
| corn starch | 0.1-2 |
| gum | 0.1-2 |
| Natural yellow colour | 0.01-1 |
| (Lutein) | |
| White pepper powder | 0.1-2 |
| Onion powder | 0.1-2 |
| Garlic powder | 0.1-2 |
| Baking powder | 0.1-2 |
| Methylcellulose | 0.1-2 |

### 1.2 Method of Preparation

### A: Vegan Beaten Egg (Shreds)

1. In a blender, blend the components listed in Table 1 or 3 for 1 minute until smooth and homogeneous.
2. The mixture is sieved to remove coarse particles.
3. The mixture is ready to be
   a. spread on baking trays and baked into plant-based omelettes in a preheated oven at 260° C. for 10 minutes; or
   b. pan-fried at low heat for 4 minutes on each side to make plant-based omelettes.
4. The omelettes are left to cool in a blast freezer for 5 minutes, followed by being cut into shreds.

### B: Vegan Beaten Egg (Patty)

1. In a blender, blend the components listed in Table 2 or 4 for 1 minute until smooth and homogenous.
2. The mixture is sieved to remove coarse particles.
3. The mixture is filled into round molds and baked at 160° C. for 20 minutes.

In some embodiments of the invention, the relative amounts of the vegan beaten egg (shreds) composition components are as shown in Table 3.

TABLE 3
Composition of vegan beaten egg (shreds)

| Ingredient | Composition (wt %) |
|---|---|
| tofu | 60.4 |
| Faba bean protein | 8.2 |
| concentrate | |
| rice flour | 1.4 |
| water | 23.9 |
| Kala Namak (Black salt) | 0.56 |
| Coconut cream | 2.8 |
| tapioca starch | 0.56 |
| corn starch | 0.56 |
| gum | 0.7 |
| Garlic powder | 0.42 |
| Onion powder | 0.22 |
| White pepper powder | 0.17 |
| Natural yellow colour | 0.08 |
| (Lutein) | |

In some embodiments of the invention, the relative amounts of the vegan beaten egg (patty) composition components are as shown in Table 4.

TABLE 4
Composition of vegan beaten egg (patty)

| Ingredient | Composition (wt %) |
|---|---|
| tofu | 67.3 |
| Pea protein isolate | 1.9 |
| rice flour | 6.3 |
| water | 12.5 |
| Kala Namak (Black salt) | 0.6 |
| Coconut cream | 6.3 |
| tapioca starch | 0.63 |
| corn starch | 0.63 |
| gum | 0.94 |
| Natural yellow colour | 0.09 |
| (Lutein) | |
| White pepper powder | 0.19 |
| Onion powder | 0.13 |
| Garlic powder | 0.31 |
| Baking powder | 1 |
| Methylcellulose | 1.3 |

### Example 2: Comparison with Known Vegan Egg and Natural Egg Omelette

Characteristics of omelettes produced using the vegan beaten egg composition were compared to omelettes produced using known vegan egg mixtures and natural chicken egg. The omelettes were assessed by four untrained in-house panelists, comprising 2 females and 2 males, aged between 22 and 29 years. The panelists were not involved in the sample preparation and assessment was conducted under identical light (daylight) at room temperature. The samples were prepared for each panelist to provide their opinions on color and appearance, odor, taste, texture and overall acceptability. In addition to qualitative assessment, panelists were also asked to assign scores using a nine-point hedonic scale as follows: Like extremely—9; Like very much-8; Like moderately—7; Like slightly—6; Neither like nor dislike—5; Dislike slightly—4; Dislike moderately—3; Dislike very much—2; Dislike extremely—1. Natural egg served as a positive control with a score of 9 for every single parameter.

### 2.1 Sensory Characteristics

i) Comparison with (1) JUST Egg™ Folded Vegan Omelette

The JUST Egg Folded product by Eat Just, Inc. was baked according to the instructions written on the packaging. This omelette exhibited a better closeness to the chicken egg, in terms of colour, springiness, bounciness, stretchiness and cohesiveness. However, the omelette lacked “eggy” taste and aroma.

JUST Egg Folded comprises water, mung bean protein isolate, canola oil, corn starch, baking powder, dehydrated garlic, dehydrated onion, natural colorant, salt and transglutaminase.

ii) Comparison with (2) VeganEgg™ Vegan Omelette

Based on the method of preparation stated on the packaging, the VeganEgg powder by Follow Your Heart® was mixed with water to form the light-yellow mixture and pan-fried. It was observed that the mixture solidified fast when heat was applied. Based on the results of sensory evaluation, the taste and flavour of the vegan egg did not resemble chicken egg. In terms of texture, the vegan egg omelette was overly springy, bouncy and stretchy.

VeganEgg comprises organic soymilk powder, modified cellulose, gellan gum, cellulose, calcium lactate, carrageenan, natural flavors, nutritional yeast, black salt, natural color.

iii) Comparison with (3) Minimalist Baker Vegan Omelette

A Minimalist Baker omelette composition was pan-fried then baked according to instructions on the minimalistbakerdotcom/simple-vegan-omelet/website, using the components listed in Table 5.

TABLE 5

| Ingredient | Composition | |
|---|---|---|
| Silken tofu | 142 | g |
| hummus | 30 | g |
| garlic | 2 cloves | |
| nutritional yeast | 6 | g |
| corn starch | 2 | g |
| Paprika | 0.7 | g |
| Olive oil | For cooking | |
| Water | 1 | tsp |

Panelists reported a grey tone, oat milk-like colour for the Minimalist Baker, which was undesirable as it did not resemble the true colour of a chicken egg-derived omelette. An undesirable taste and odor profile, largely contributed by the garlic and nutritional yeast, was also identified.

Qualitative assessment showed that the vegan omelette lacked springiness, bounciness, stretchiness, and cohesiveness.

Panelists also commented on the crack lines shown by the resulting omelette, which created a perception of dryness. FIG. 1 shows a vegan omelette using the Minimalist Baker composition.

iv) Comparison with (4) Edgy Veg Vegan Omelette

An Edgy Veg vegan omelette composition was pan-fried according to instructions on the website worldwidewebdottheedgyvegdotcom/2019/07/22/how-to-make-a-vegan-omelet/.

The ingredients used are listed in the following table:

TABLE 6

| Ingredient | Composition | |
|---|---|---|
| Shallot | 1 | pc |
| Tofu | 200 g silken + 200 g firm | |
| Nutritional yeast | 3 | tbsp |
| Olive oil | 2 | tbsp |
| Garlic powder | 2 | tsp |
| Turmeric | ½ | tsp |
| Black salt | 1 | tsp |
| Black pepper | ¼ | tsp |
| Rice flour | 3 | tbsp |
| Corn starch | 1 | tbsp |

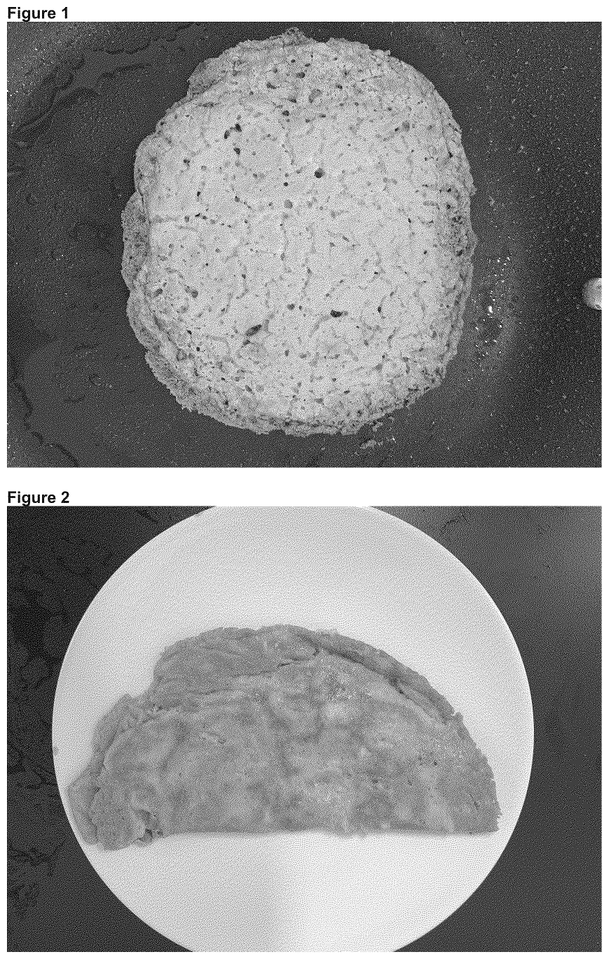

Compared to the Minimalist Baker and Hidden Veggies vegan omelettes, the Edgy Veg omelette rated higher for overall appearance, taste, colour, aroma, as well as overall acceptability. However, it is by no means suggesting that the Edgy Veg omelette resembled omelettes made with chicken egg. Although it yielded a better result during the sensory evaluation in comparison to omelettes (3) and (5), the panelists still in general provided unfavorable reactions especially in terms of texture. In contrast to omelette (3), the Edgy Veg omelette was considered to be too wet and too weak. Consistently, numerous panelists highlighted that the texture seemed to be closer to scrambled egg or even mushy tofu, than to an omelette. FIG. 2 shows a vegan omelette produced using the Edgy Veg composition.

v) Comparison with (5) the Hidden Veggies Vegan Omelette

The Hidden Veggies vegan omelette composition was pan-fried according to instructions on the website thehiddenveggiesdotcom/chickpea-omelette-the-best-vegan-omelette/. The ingredients used are listed in the following table:

TABLE 7

| Ingredient | Composition | |
|---|---|---|
| Chickpea flour | 30 | g |
| Water | 78.86 | g |
| Nutritional yeast | 1 | tbsp |
| Black salt | ¼ | tsp |

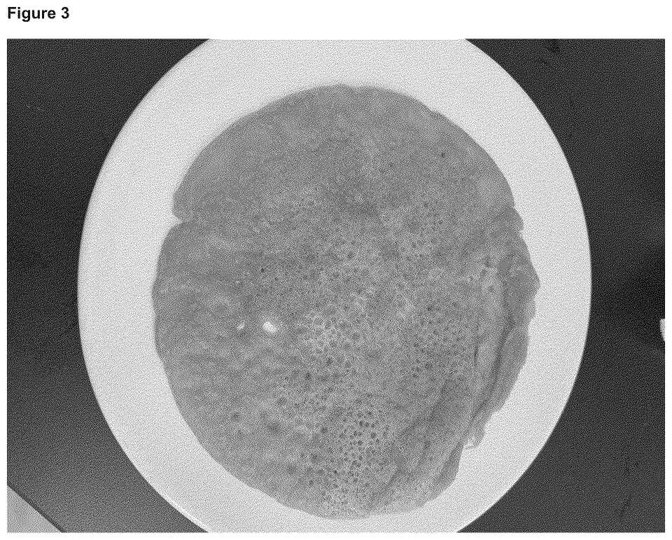

Similar to the Minimalist Baker omelette, panelists noted the absence of springiness, bounciness, stretchiness, cohesiveness which are some of the textural parameters associated with natural omelette. Foul odour resembling wet socks was also reported. Overall appearance also reminded the panelists more of a very thin pancake rather than an omelette. FIG. 3 shows a vegan omelette produced using the Hidden Veggies composition.

### Advantages of Vegan Egg Omelettes Over Known Vegan Eggs and Chicken Egg:

For comparison, the panelists also assessed a vegan baked omelette of the invention, comprising the vegan beaten egg composition shown in Table 4 and produced by the method in Example 1.2 (patty).

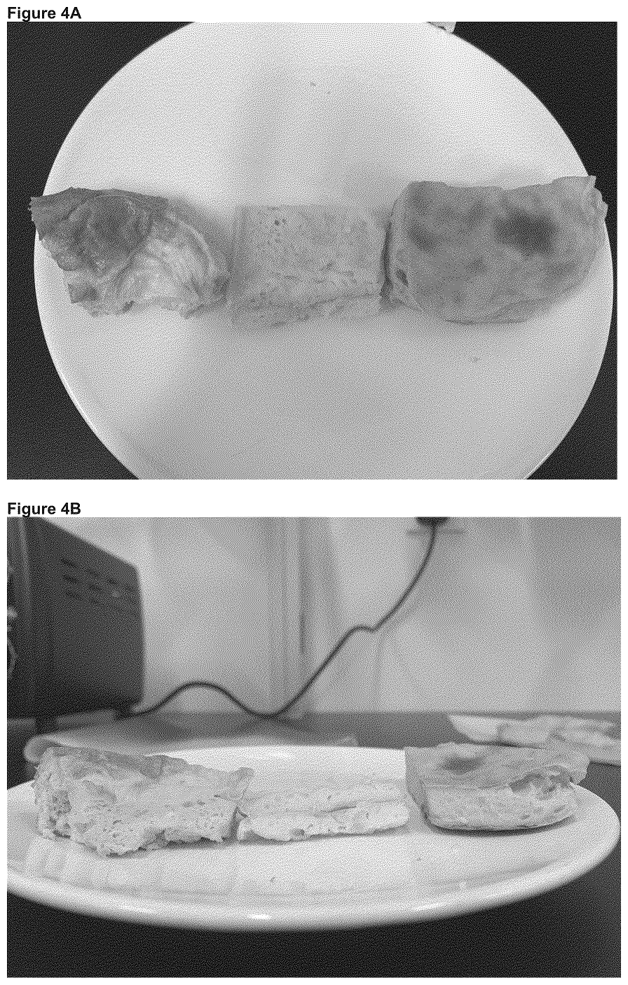

The chicken egg, JUST egg folded, and the vegan egg omelette of the invention, shown in FIGS. 4A and 4B, were prepared by baking the compositions in the oven for 10 minutes, 15 minutes and 20 minutes, respectively.

FIG. 4A shows, from left to right, a top view of a baked chicken egg, JUST Egg, and vegan egg omelette of the invention. FIG. 4B shows, from left to right, a side view of a baked chicken egg, JUST Egg folded, and vegan egg omelette of the invention.

According to the panelists, the vegan egg omelette of the invention exhibited a closer similarity to the chicken egg, specifically in terms of colour, height, height/weight ratio, springiness, and resistance to stress and especially in relation to the mentioned sensory properties. The comparison of characteristics of a vegan omelette produced according to the invention, with known vegan egg compositions and natural egg omelette is summarized in Table 8.

TABLE 8
Summary of the Advantages of Vegan egg omelette
over known vegan egg products & Chicken Egg

| | | | 3: Vegan | 4: Vegan | 5: Vegan | | |
|---|---|---|---|---|---|---|---|
| | 1: Just | | Omelette | Omelette | Omelette | | |
| | Egg ™ | 2: Vegan | Recipe by | Recipe by | Recipe by | Chicken | Vegan |
| | Folded | Egg ™ | Minimalist | the Edgy | The Hidden | Eggs | egg of |
| | (57 g) | (10 g) | Baker | Veg | Veggies | (50 g) | invention |
| Taste | 4 | 2 | 2 | 4 | 3 | 9 | 7 |
| Odour | 4 | 1 | 2 | 3 | 1 | 9 | 6 |
| Texture | 6 | 1 | 2 | 2 | 2 | 9 | 7 |
| Colour | 5 | 3 | 1 | 2 | 1 | 9 | 6 |
| Appearance | 5 | 1 | 1 | 4 | 2 | 9 | 7 |
| Overall | 4 | 2 | 2 | 3 | 2 | 9 | 7 |
| Acceptability | | | | | | | |

### Example 3: Applications of Vegan Beaten Egg Composition

### i) Vegan Egg Shreds

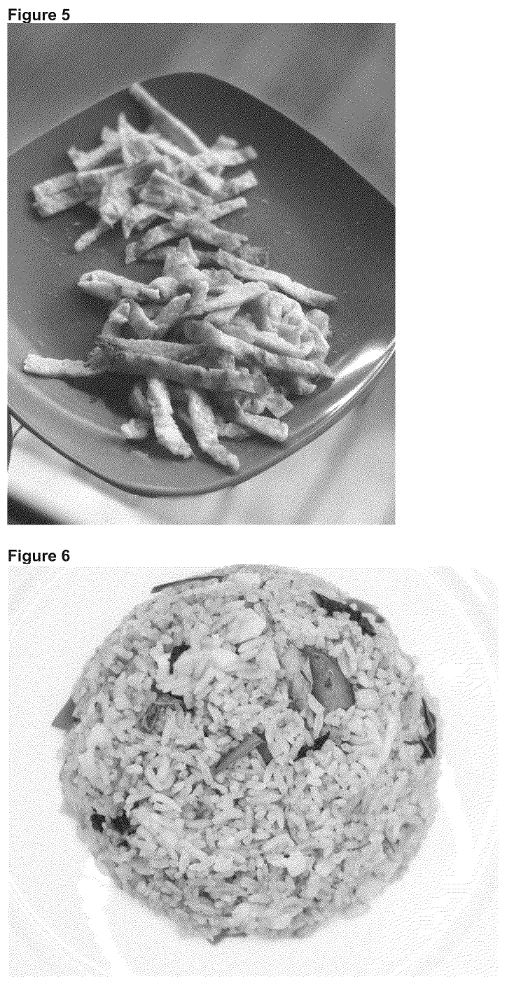

Vegan egg Shreds (method of preparation described in Example 1.2) produced from the vegan beaten egg composition of the invention present very similar organoleptic and haptic properties to a real chicken egg omelette and with improved health qualities. Vegan egg Shreds of the invention can directly replace a shredded chicken egg omelette in Asian dishes, including but not limited to fried rice, mee goreng, pad thai. FIG. 5 shows a photograph of Vegan egg Shreds of the invention (in the front), and stir-fried chicken egg strips (in the rear). FIG. 6 shows a photograph of the Vegan egg Shreds of the invention added to fried rice. Vegan egg Shreds of the invention can also be used in Western dishes including but not limited to egg sandwiches and salads with egg as garnish.

### ii) Vegan Egg Patty

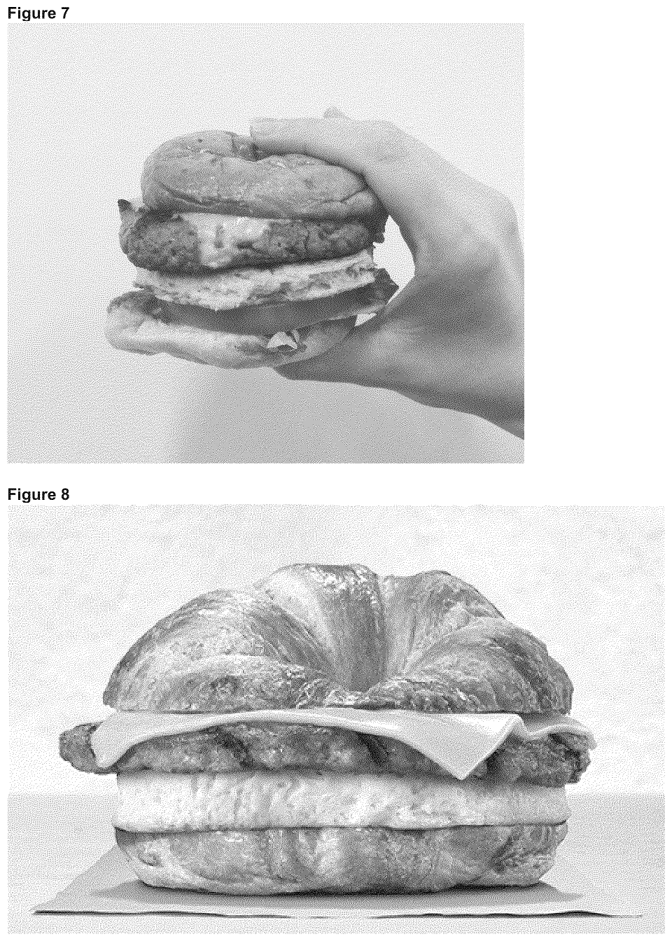

The Vegan egg Patty (method of preparation described in Example 1.2) produced from the vegan beaten egg composition of the invention presents very similar organoleptic and haptic properties to a real chicken egg patty and with improved health qualities. The Vegan egg Patty can directly replace a chicken egg patty in burgers and buns. FIG. 7 shows a photograph of a Vegan egg patty of the invention used in a burger. FIG. 8 shows a photograph of a BurgerKing® Croissan'wich with a chicken egg patty. The vegan egg patty of the invention could be used to replace the chicken egg patty in this application.

Any listing or discussion of an apparently prior-published document in this specification should not necessarily be taken as an acknowledgement that such document is part of the state of the art or is common general knowledge.

### REFERENCES

Lin Lin, Hanja Allemekinders, Angela Dansby, Lisa Campbell, Shaunda Durance-Tod, Alvin Berger, Peter J H Jones, Evidence of health benefits of canola oil, Nutrition Reviews, 71 (6): 370-385 (2013).
U.S. Pat. No. 7,186,807; Salome, Jean-Paul et al., “Process for extracting the components of pea flour” (2003).

1. A plant-based vegan simulated beaten egg composition, comprising;
tofu, flour, water, kala namak, a plant-based cream, tapioca starch, corn starch, natural yellow food colouring, white pepper powder, garlic powder, onion powder, and a gum.

2. The plant-based vegan simulated beaten egg composition of claim 1, wherein;
the tofu is silken tofu; and/or
the flour is selected from rice, wheat, chickpea, buckwheat, corn, potato and spelt, preferably rice flour; and/or
the plant-based cream is selected from coconut, rice, oat, cashew and almond cream, preferably coconut cream; and/or
the gum is selected from a group of elastic gel-forming gums, preferably high acyl gellan gum; and/or
the natural yellow food colouring is selected from the group comprising;
lutein (IUPAC ID: 4-[18-(4-hydroxy-2,6,6-trimethylcyclohex-2-en-1-yl)-3,7,12,16-tetramethyloctadeca-1,3,5,7,9,11,13,15,17-nonaenyl]-3,5,5-trimethylcyclohex-3-en-1-ol); and
beta carotene (IUPAC ID: 1,3,3-trimethyl-2-[(1E,3E,5E,7E,9E,11E,13E,15E,17E)-3,7,12,16-tetramethyl-18-(2,6,6-trimethylcyclohexen-1-yl)octadeca-1,3,5,7,9,11,13,15,17-nonaenyl]cyclohexene).

3. The plant-based vegan simulated beaten egg composition of claim 1, further comprising;
(i) plant protein; or
(ii) plant protein, baking powder, and methylcellulose.

4. The plant-based vegan simulated beaten egg composition of claim 3(ii), wherein the baking powder is a single-acting baking powder.

5. The plant-based vegan simulated beaten egg composition of claim 3(i), comprising;
tofu in an amount of about 60-65 wt %,
plant protein in an amount of about 5-10 wt %,
flour in an amount of about 1-5 wt %,
kala namak in an amount of about 0.5-2 wt %,
plant-based cream in an amount of about 1-5 wt %,
tapioca starch in an amount of about 0.5-2 wt %,
corn starch in an amount of about 0.5-2 wt %,
gum in an amount of about 0.5-2 wt %,
garlic powder in an amount of about 0.1-2 wt %,
onion powder in an amount of about 0.1-2 wt %,
white pepper powder in an amount of about 0.1-2 wt %,
natural yellow colouring in an amount of about 0.01-1 wt %, and
water in an amount of about 20-25 wt %, by weight of said beaten egg composition.

6. The plant-based vegan simulated beaten egg composition of claim 3(ii), comprising;
tofu in an amount of about 60-70 wt %,
plant protein in an amount of about 1-5 wt %,
flour in an amount of about 5-10 wt %,
kala namak in an amount of about 0.1-2 wt %,
plant-based cream in an amount of about 5-10 wt %,
tapioca starch in an amount of about 0.1-2 wt %,
corn starch in an amount of about 0.1-2 wt %,
gum in an amount of about 0.1-2 wt %,
baking powder in an amount of about 0.1-2 wt %,
natural yellow colouring in an amount of about 0.01-1 wt %,
white pepper powder in an amount of about 0.1-2 wt %,
onion powder in an amount of about 0.1-2 wt %,
garlic powder in an amount of about 0.1-2 wt %,
methylcellulose in an amount of about 0.1-2 wt %, and
water in an amount of about 10-15 wt %, by weight of said beaten egg composition.

7. The plant-based vegan simulated beaten egg composition of claim 3(i), wherein the plant protein is fava bean protein, preferably fava bean concentrate.

8. The plant-based vegan simulated beaten egg composition of claim 3(ii), wherein the plant protein is pea protein, preferably pea protein isolate.

9. The plant-based vegan simulated beaten egg composition of claim 7, comprising:
tofu in an amount of about 60.4 wt %,
fava bean protein concentrate in an amount of about 8.2 wt %,
flour in an amount of about 1.4 wt %,
kala namak in an amount of about 0.56 wt %,
coconut cream in an amount of about 2.8 wt %,
tapioca starch in an amount of about 0.56 wt %,
corn starch in an amount of about 0.56 wt %,
gum in an amount of about 0.7 wt %,
garlic powder in an amount of about 0.42 wt %,
onion powder in an amount of about 0.22 wt %,
white pepper powder in an amount of about 0.17 wt %,
natural yellow colouring in an amount of about 0.08 wt %, and
water in an amount of about 23.9 wt %, by weight of said beaten egg composition.

10. The plant-based vegan simulated beaten egg composition of claim 8, comprising:
tofu in an amount of about 67.3 wt %,
pea protein isolate in an amount of about 1.9 wt %,
rice flour in an amount of about 6.3 wt %,
kala namak in an amount of about 0.6 wt %,
coconut cream in an amount of about 6.3 wt %,
tapioca starch in an amount of about 0.63 wt %,
corn starch in an amount of about 0.63 wt %,
gum in an amount of about 0.94 wt %,
baking powder in an amount of about 1 wt %,
natural yellow colouring (lutein) in an amount of about 0.09 wt %,
white pepper powder in an amount of about 0.19 wt %,
onion powder in an amount of about 0.13 wt %,
garlic powder in an amount of about 0.31 wt %,
methylcellulose in an amount of about 1.3 wt %, and
water in an amount of about 12.5 wt %, by weight of said beaten egg composition.

11. A method of producing a vegan simulated beaten egg composition of claim 3, comprising the steps:
i) in a blender, mix tofu, plant protein, flour, water, black salt, plant-based cream, tapioca starch, corn starch, gum, colouring, garlic powder, onion powder and white pepper powder for 1 minute until smooth and homogeneous; or
ii) in a blender, mix tofu, plant protein, flour, water, black salt, plant-based cream, tapioca starch, corn starch, gum, baking powder, colouring, white pepper powder, onion powder, garlic powder and methylcellulose for 1 minute until smooth and homogeneous,
wherein the composition of (i) may be used for preparation of pan-fried omelette which may further be cut into vegan egg shreds, and
wherein the composition of (ii) may be used for the preparation of a vegan oven-baked omelette or vegan oven-baked egg patty.

12. A vegan simulated omelette, vegan simulated egg patty or vegan simulated egg shreds, produced by the method of claim 11.

13. A kit or combination comprising a plant-based vegan simulated beaten egg composition of claim 1.

14. The plant-based vegan simulated beaten egg composition of claim 2, further comprising;
(i) plant protein; or
(ii) plant protein, baking powder, and methylcellulose.
